(19) United States
(12) Patent Application Publication
(10) Pub. No.: US 2012/0326975 A1
(43) Pub. Date: Dec. 27, 2012

(54) INPUT DEVICE AND INPUT METHOD

(75) Inventors: Hsin-Chia Chen, HsinChu (TW); Yu-Hao Huang, HsinChu (TW); Yen-Min Chang, HsinChu (TW)

(73) Assignee: PixArt Imaging Incorporation, R.O.C.

(21) Appl. No.: 13/603,337

(22) Filed: Sep. 4, 2012

Related U.S. Application Data
(63) Continuation-in-part of application No. 12/793,101, filed on Jun. 3, 2010.

(51) Int. Cl. G06F 3/033

(52) U.S. Cl. 345/156

(57) ABSTRACT

The present invention discloses an input device and an input method. The input device comprises: an image acquiring device for acquire sequence of images when an object moves in front of the field of view of the image acquiring device; and a processor for generating a rotation signal according to the rotation status of the object.

### CROSS REFERENCE

The present invention is a continuation-in-part application of U.S. Ser. No. 12/793,101 filed on Jun. 3, 2010.

### BACKGROUND OF THE INVENTION

1. Field of Invention

The present invention relates to an input device and an input method.

2. Description of Related Art

Among various types of input devices, touch-control devices have become widely used in many applications, such as touchpad in a notebook computer, touch screen in an automatic teller machine, touch panel in a PDA or an electronic dictionary, etc. Presently there are resistance-type and capacitance-type touch control devices. A resistance-type touch control device senses the touched position by voltage drop; when its screen is touched, a circuit is conducted which results in a voltage drop in the horizontal axis and a voltage drop in the vertical axis. The amounts of the voltage drops are different depending on the touched position, and therefore the x-y coordinates of the touched position may be obtained. A capacitance-type touch control device includes an ITO (Indium Tin Oxide) glass substrate. A uniform electric field is formed over its surface by discharging from its corners. When a conductive object, such as a human finger, conducts current away from the electric field, the lost amount of current may be used to calculate the x-y coordinates of the touched position.

Besides resistance-type and capacitance-type touch control devices, U.S. Pat. Nos. 6,057,540; 6,621,483; and 6,677,929 disclose other types of input devices.

Typically, the above mentioned input devices generate movement information (e.g., for moving a cursor) according to locus of movement, and generate control information (e.g., for opening a menu, selecting an item from the menu, etc.) by “single click” and/or “double click”. The present invention provides another way to generate control information, in which more control instructions are available; it also provides a suitable solution to product applications where “single click” and “double click” can not be conveniently achieved, e.g., because of hardware limitations.

### SUMMARY

An object of the present invention is to provide an input device and an input method, wherein control information is generated in a manner different from that in prior art.

To achieve the above and other objects, and from one aspect of the present invention, an input device comprises: a device for receiving input signals; and a processor for generating control information, such as a rotation signal, according to comparison between a first difference between two input signals in a first direction and a second difference between two input signals in a second direction.

From another aspect of the present invention, an input method comprises: receiving input signals; comparing a first difference between two input signals in a first direction and a second difference between two input signals in a second direction; and generating control information according to the comparison result.

Preferably, a direction state is generated according to the first and second differences, and a determination is made as to whether there is any rotation and if yes, the direction of rotation, according to a change of the direction state.

Another objective of the present invention is to determine whether the rotation happened according to the change of the direction state, such as rotation vector, rotating angle, angle velocity, velocity, radius of rotation or length of track, and etc. Then, the determination of rotation is applied for operating the application program of an electronic device. For example, referring to one embodiment of the present invention, the determination of rotation is applied to generate a rotation signal, and the rotation signal is applied for launching a command according to the rotation angle or angle velocity. When the electronic device has an application program for dialing, the electronic device may show a circle dialer, and the command may be applied for rotating the dialer and dialing.

Another objective of the present invention is to determine whether the rotation happened according to the rotation of a user's paw. And the determination of rotation is applied for operating a software menu according to the rotation direction and velocity of the object indicated by the rotation signal. For example, a clockwise rotation for two circles may be applied for moving the selection icon of the software menu two icons rightward. Thus the user can selection the desired icon by clear gesture, such as moving his paw in a circle, without misoperation. The determined of rotation is made according to rotation vector, rotating angle, angle velocity, velocity, radius of rotation or length of track by the user, such as moving his paw.

More control information can be generated according to the magnitude of rotation.

### BRIEF DESCRIPTION OF THE DRAWINGS

These and other features, aspects, and advantages of the present invention will become better understood with reference to the following description, appended claims, and accompanying drawings.

FIG. 1 shows an example wherein the present invention is applied to a mobile phone.

FIG. 2 shows the internal structure of FIG. 1.

FIG. 3 explains how to determine a direction state according to an embodiment of the present invention.

FIG. 4 is a flow chart explaining the process to determine a direction state according to an embodiment of the present invention.

FIG. 5 shows clockwise and counter clockwise rotations.

FIG. 6 is a flow chart explaining the process to generate a control instruction from rotation information according to an embodiment of the present invention.

FIG. 7 is a flow chart explaining the process to generate a control instruction from rotation magnitude according to an embodiment of the present invention.

FIG. 8 is another embodiment using the present invention.

FIGS. 9A-9C are operation explanation of how an electronic device operates with the embodiment shown in FIG. 8.

### DESCRIPTION OF THE PREFERRED EMBODIMENTS

The input device according to the present invention may be applied to touchpad, touch panel, touch screen, and other applications such as in portable electronic devices such as mobile phone, personal digital assistant (PDA), etc. As a matter of fact, for the device and method of the present invention to work, they do not require “touching”. The term “touch control” is used in the context of the specification to imply that the present invention provides an alternative for the conventional touch control device. It does not mean that the device according to the present invention detects the position of an input device by its touching.

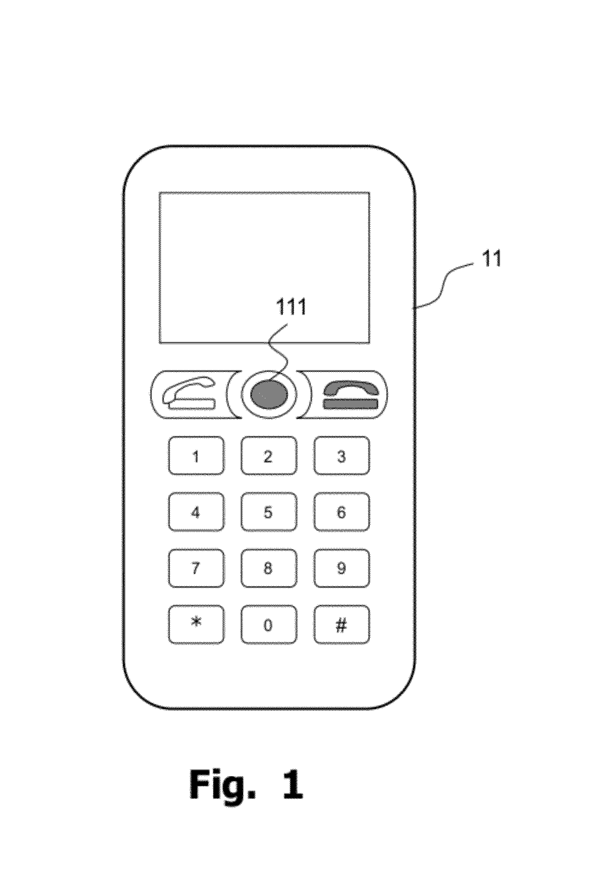

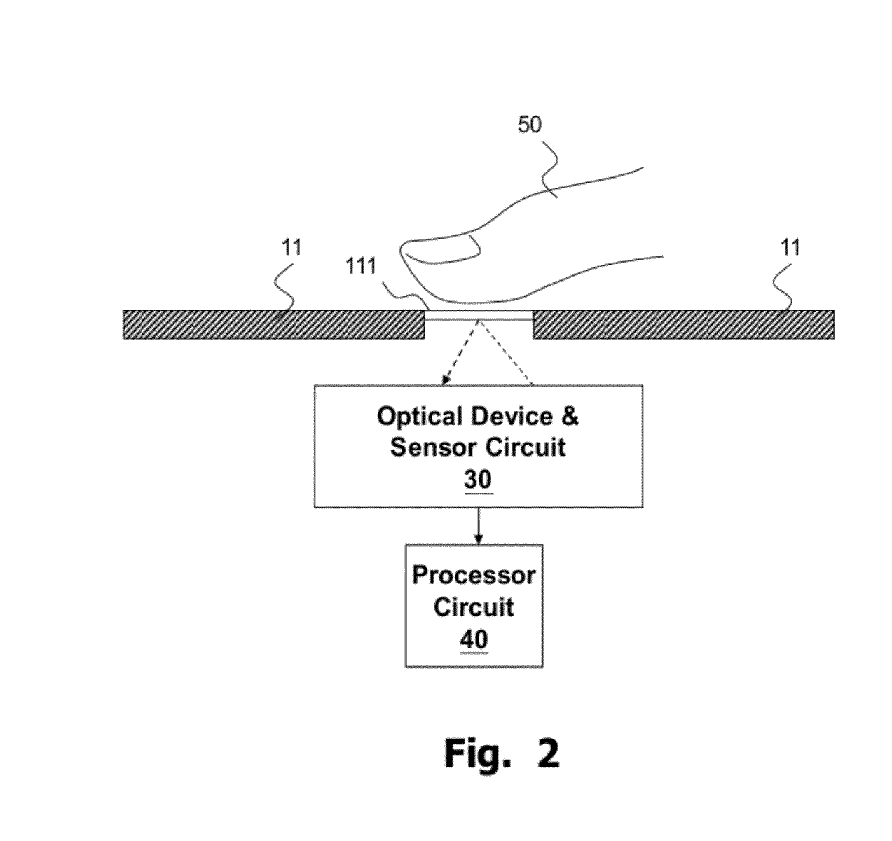

In no matter the resistance-type, capacitance-type, or optical input device, they all have to determine the locus of movement. FIG. 1 shows an example wherein the present invention is applied to a mobile phone; in this embodiment, an instruction is inputted and detected by an optical way. The mobile phone includes a housing 11 which is provided with an instruction input position 111. In a small portable electronic device, the instruction input position 111 can have a very small size; for example, most or all of its surface maybe coverable by a human finger. As shown in FIG. 2, a user can move his/her finger 50 on the instruction input position 111; a optical device and sensor circuit 30 projects light and receives the fingerprint image from the instruction input position 111. The optical image is converted to electronic signals to be processed by a processor 40, to generate movement information and control information. The movement information can be generated, e.g., by comparing the images at the instruction input position 111 at two time points, to determine the direction, distance and speed of the movement.

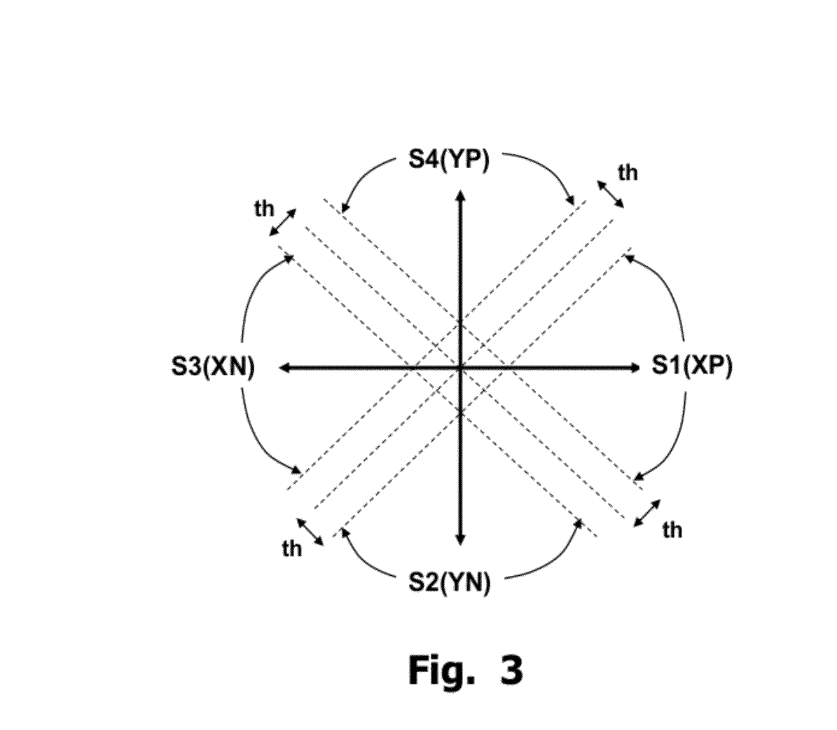

After movement information is generated, control information can be generated based on the movement information. In this embodiment, direction information of up, down, left and right is first generated according to the direction of locus movement. Referring to FIG. 3, in one embodiment, the algorithm for determining direction is as follows:
if |ΔX|>|ΔY+th|, and ΔX>0 . . . direction state S1 (XP)
if |ΔX|>|ΔY+th|, and ΔX<0 . . . direction state S3 (XN)
if |ΔY|>|ΔX+th|, and ΔY>0 . . . direction state S4 (YP)
if |ΔY|>|ΔX+th|, and ΔY<0 . . . direction state S2(YN)
   wherein “ΔX” and “ΔY” are the differences in X and Y coordinates between two time points, respectively; “th” is a threshold to ensure a valid determined state if the difference between the absolute values of ΔX and ΔY is larger than this predetermined threshold; XP, XN, YP, and YN represent positive X coordinate direction, negative X coordinate direction, positive Y coordinate direction, and negative Y coordinate direction, respectively.

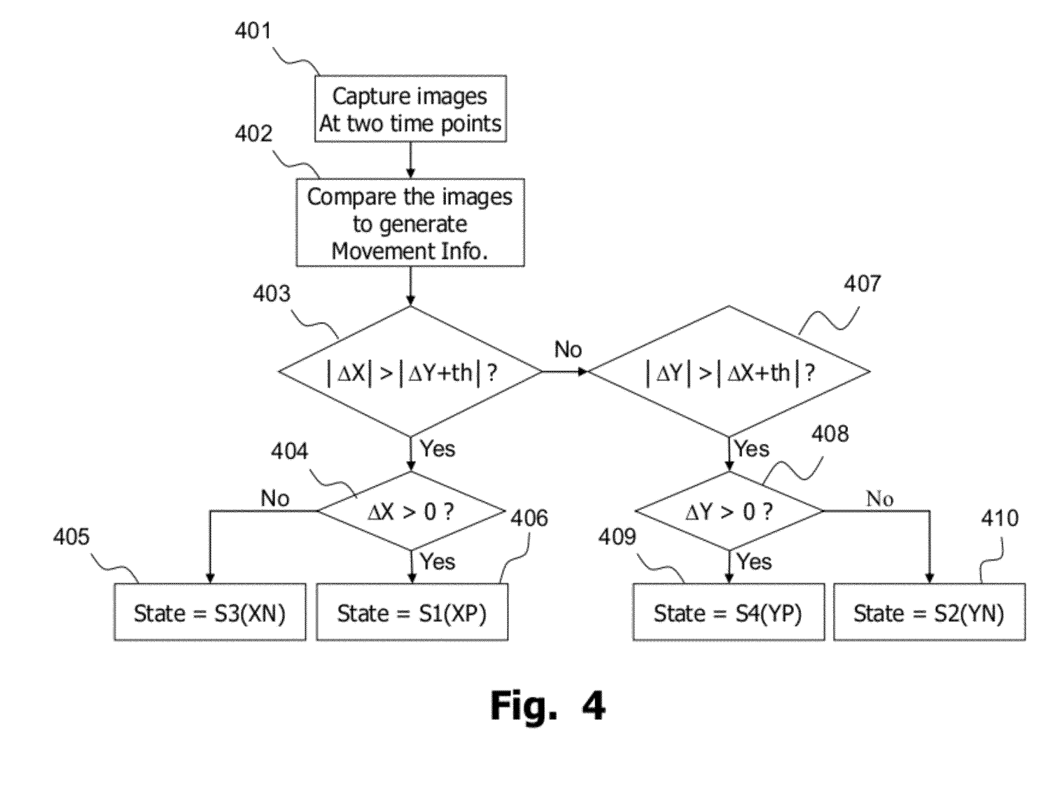

FIG. 4 shows, by way of example, a process flow to carryout the above algorithm. First at the step 401, two images at two time points are captured. Next at the step 402, the two images are compared with each other to determine the differences in X and Y coordinates. Thereafter, the steps 403-410 are taken to determine the direction state. Obviously, some of the steps in this process flow can be interchanged; this process flow is not the only way to carry out the above algorithm.

The determined direction state can be used, for example, to switch between menus. According to the present invention, a change in the direction state is further used to generate other control information, such as to replace for the “single click” and “double click”, to select an item in a menu, or for other control functions.

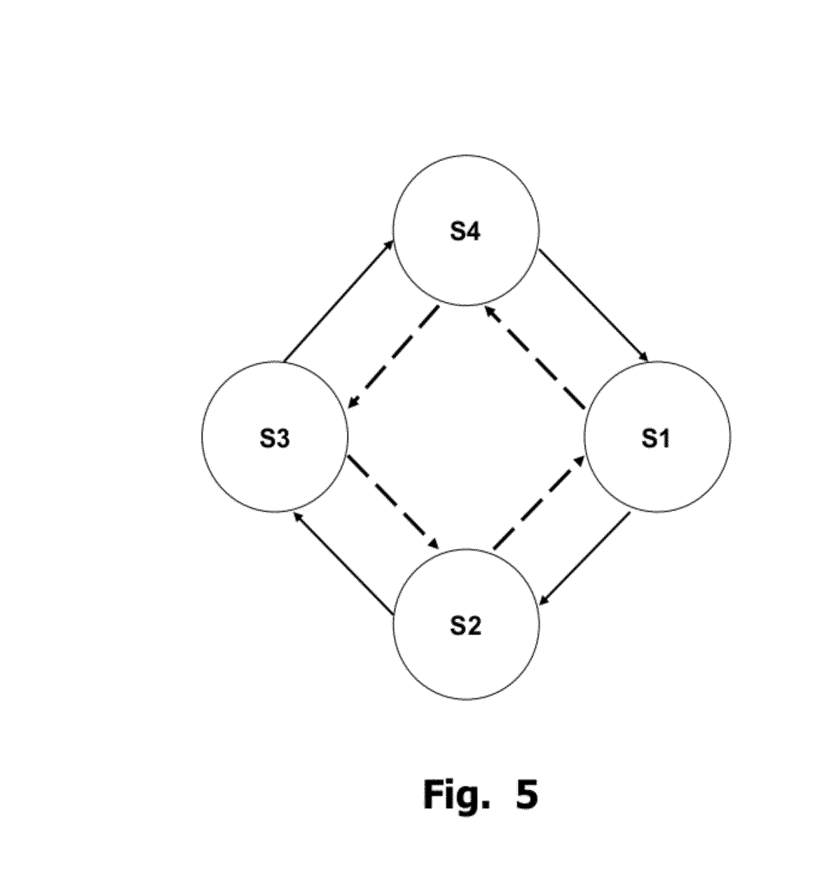

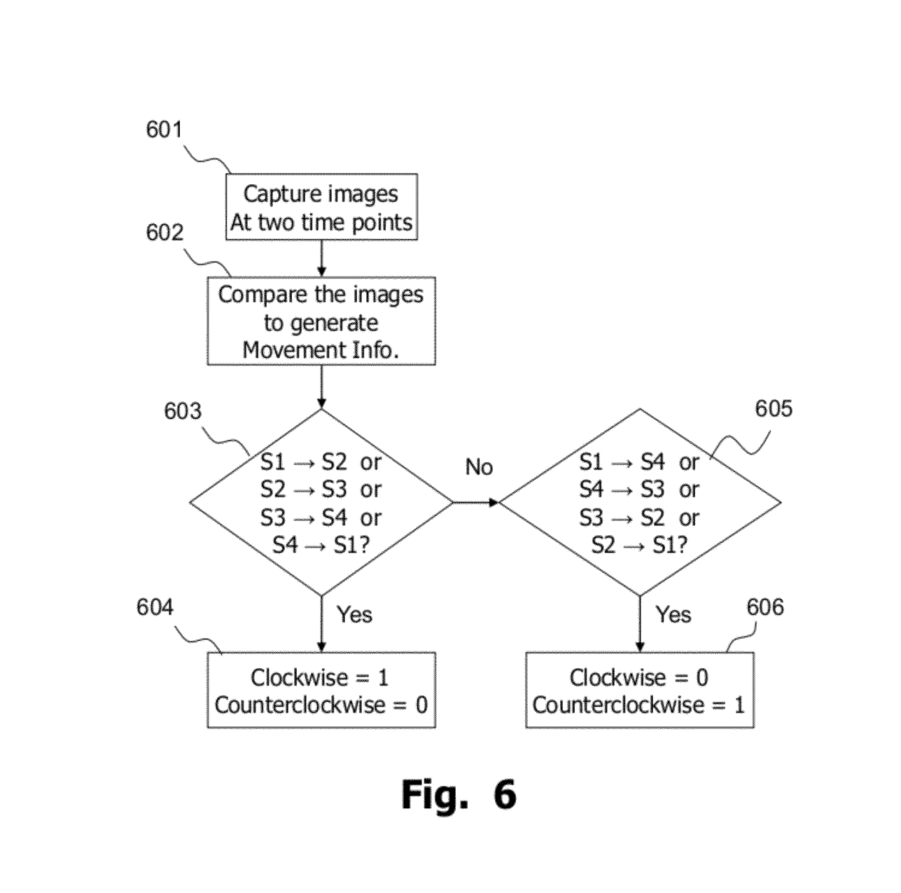

More specifically, referring to FIG. 5 and the steps 601-606 in FIG. 6, in one embodiment of the present invention, a change in the direction state is used to determine whether there is a rotation and the direction of rotation, to generate more control information. The algorithm for determination for example can be as follows:
when the direction state changes from S1 to S2, or from S2 to S3, or from S3 to S4, or from S4 to S1:
   clockwise rotation, set the clockwise flag to 1, and counterclockwise flag to 0
when the direction state changes from S1 to S4, or from S4 to S3, or from S3 to S2, or from S2 to S1:
   counterclockwise rotation, set the counterclockwise flag to 1, and clockwise flag to 0

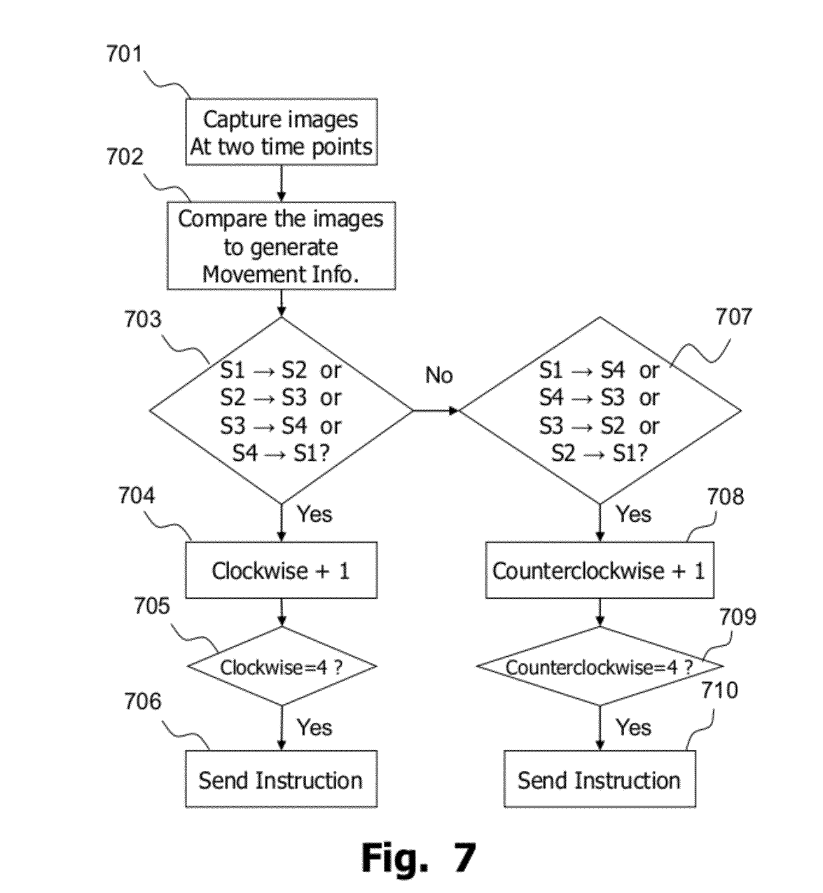

“The existence of rotation” and “the direction of rotation” can each be defined as an individual control instruction. Moreover, referring to FIG. 5 and the steps 701-710 in FIG. 7, in another embodiment of the present invention, the magnitude of rotation can be used to define more instructions, for example as follows:
when the direction state changes from S1 to S2, or from S2 to S3, or from S3 to S4, or from S4 to S1:
   clockwise rotation, add 1 to the clockwise count, and reset the counterclockwise count to 0
when the direction state changes from S1 to S4, or from S4 to S3, or from S3 to S2, or from S2 to S1:
   counterclockwise rotation, add 1 to the counterclockwise count, and reset the clockwise count to 0
when the clockwise count or the counterclockwise count reaches a predetermined number (for example, 4)
   send a corresponding instruction

Thus, more number of control instructions can be provided, as compared with the conventional “single click” and “double click”. And, because it is not required to press the instruction input position 111, on the one hand there will be no misclick error, and on the other hand it is not required to install any mechanical press-control components inside the housing 11. Such advantages are even more significant in a small size portable electronic device.

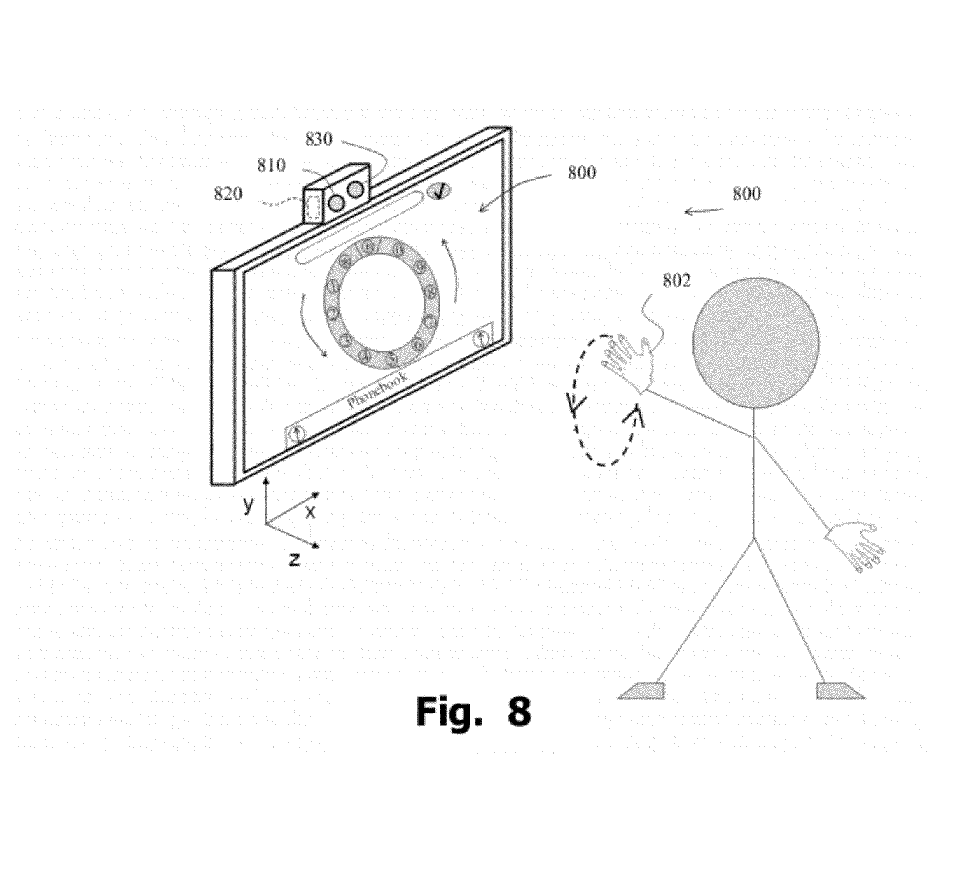

FIG. 8 shows another embodiment using the present invention. The system 800 comprises an image acquiring device 810 and a processor 820. The image acquiring device 810 is configured to acquire sequence of images when an object 802 moves in front of the field of view of the image acquiring device 810. The image acquiring device 810 is configured to detect 3-Dimensinal movement within its field of view. The image acquiring device 810 can get images based on particular light or ambient light reflected from the object 802. In the embodiment, an infra ray light 830 is applied for illuminating the object 802. The object 802 of the embodiment is an user's paw for example. Then the processor 820 determines whether a rotation of the object exists by processing the sequence of images according to the aforementioned method. Then the processor 820 generates a rotation signal.

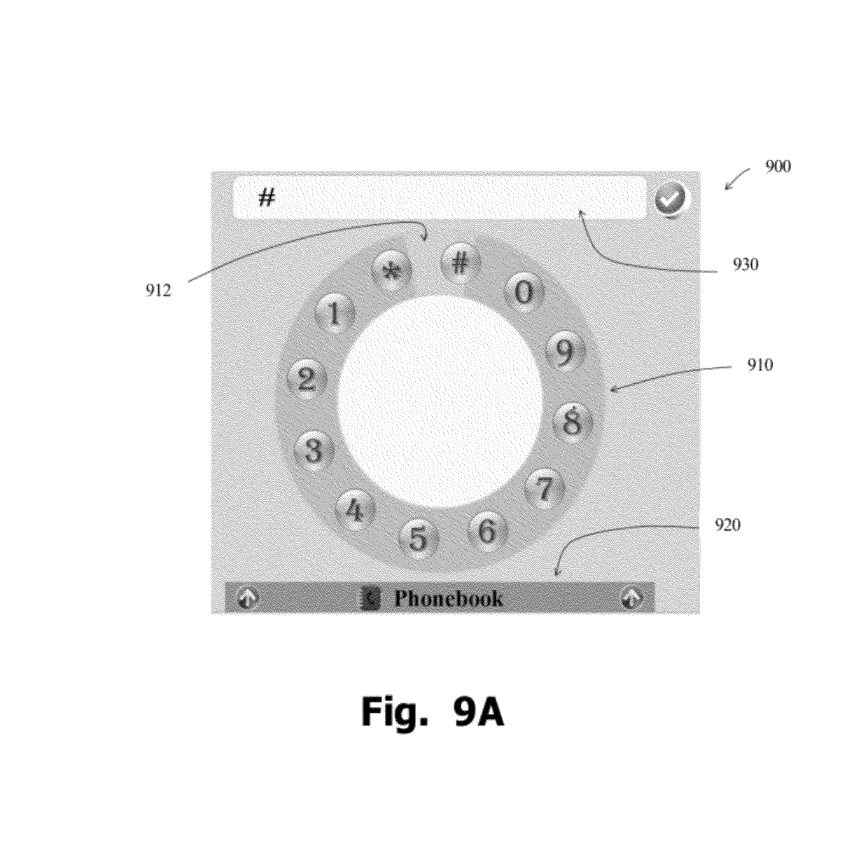

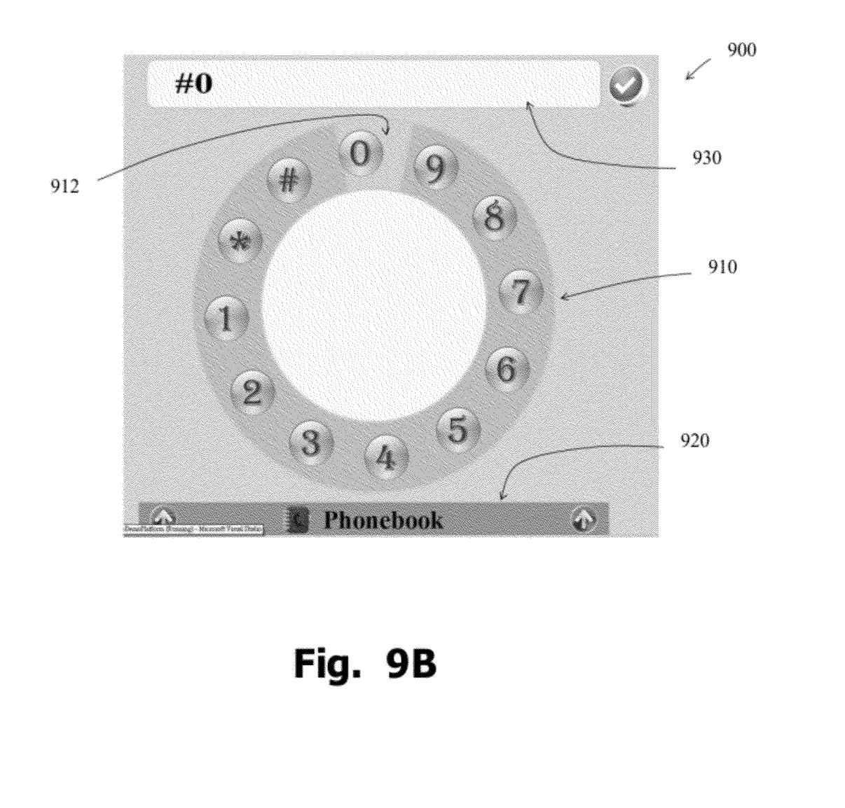

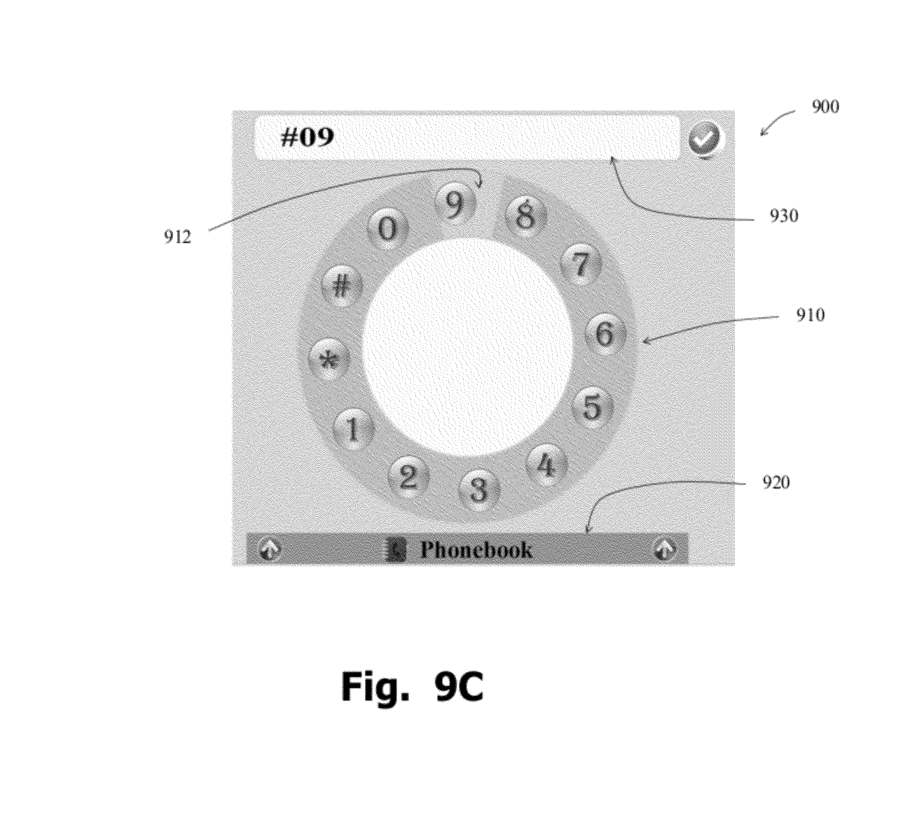

Please also referring to FIGS. 9A-9C, which shows how an electronic device 840 operates with the embodiment shown in FIG. 8 to retrieve rotation information according to the user movement.

FIG. 9A shows operation of the electronic device 840. A dialing program 900 shows a dialer 910 and a phonebook 920. The dialer 910 is configured to operate with rotation signal as shown in FIG. 9A. The dialer 910 rotates corresponding to the rotation signal. Specifically, to control the rotation velocity of the dialer 910, the system 800 is configured to output a control command according to rotation movement of the user's paw 820. For example, if the user moves his paw 820 in rotating clockwise 180 degree (refer to the axis from the electronic device 840 to the user), then a “moving rightward” command can be generated. Or, when the user moves his paw 820 in rotating clockwise 360 degree, the dialer 910 will clockwisely move two numbers further. Thus a number or a symbol located in selection zone 912 will induce a dialing number in dialing zone 930, as shown in FIGS. 9A-9C. After all numbers are generated, the user can move his paw closer to the image acquiring device 810, which will cause variation of image intensity or image dimension of paw, then the processor 820 can generate a control command to dial.

For the aforementioned application, the processor 820 can fit the control command according to the rotation velocity of the angle velocity of the paw. For example, when the processor 820 determines that the paw moves faster, the dialer 910 can rotate faster respectively, vice versa. Also, the processor 820 can continuously control the dialer 910 shortly after the paw stops according to the rotation inertia of the paw before it stops.

The spirit of the present invention has been explained in the foregoing with reference to its preferred embodiments, but it should be noted that the above is only for illustrative purpose, to help those skilled in this art to understand the present invention, not for limiting the scope of the present invention. Within the same spirit, various modifications and variations can be made by those skilled in this art. For example, the present invention can be applied to any small size or large size, portable electronic device or non-portable apparatuses, other than the mobile phone shown in FIG. 1. The method to generate instructions by the clockwise and counterclockwise rotation and count, can be used in any input device other than an optical input device. The optical device and sensor 30, and the processor 40, are shown to be two separate devices, but they can be integrated into one device, or separated into more number of devices. Instead of the horizontal and vertical coordinates (X and Y coordinates), any two axes intersected orthogonally or non-orthogonally with each other can be used as the reference coordinates. In view of the foregoing, it is intended that the present invention cover all such modifications and variations, which should be interpreted to fall within the scope of the following claims and their equivalents.

What is claimed is:

1. An input device, comprising:
an image acquiring device for acquire sequence of images when an object moves in front of the field of view of the image acquiring device; and
a processor for generating a rotation signal by:
generating a direction state indicating a positive or negative movement along a first direction or a positive or negative movement along a second direction according to a difference between a first difference between two input signals in the first direction and a second difference between the two input signals in the second direction, and
after the direction state is generated, generating the rotation signal according to a change of the direction state from movement along a first direction to movement along a second direction, or from movement along a second direction to movement along a first direction, wherein the control information is generated according to the change of the direction state without referring to absolute positions of the input signals,
wherein the processor generates the rotational signal by determining whether there is any rotation according to a change of the direction state.

2. The input device as claimed in claim 1, wherein the rotation signal is configured to operate a software menu according to the rotation direction and velocity of the object indicated by the rotation signal.

3. The input device as claimed in claim 1, wherein the rotation signal is generated according to the rotation vector, rotating angle, angle velocity, velocity, radius of rotation or length of track of the object.

4. The input device as claimed in claim 1, wherein the rotation signal is adapted to operate with a dialing program which shows a dialer, and the dialer rotates corresponding to the rotation signal.

5. The input device as claimed in claim 4, wherein the dialer moves faster when the object moves faster, vice versa.

6. The input device as claimed in claim 4, wherein the processor is configured to continuously control the dialer shortly after the object stops according to the rotation inertia of the object before it stops.
